(19) United States
(12) Patent Application Publication
(10) Pub. No.: US 2022/0216637 A1
(43) Pub. Date: Jul. 7, 2022

(54) ELECTRICAL CONNECTOR AND METHOD FOR LOCKING CONNECTION TERMINAL IN SAID ELECTRICAL CONNECTOR

(71) Applicant: DELTA PLUS CO., LTD., MIE (JP)

(72) Inventor: TSUGIO AMBO, SAITAMA (JP)

(21) Appl. No.: 17/611,178

(22) PCT Filed: Jun. 1, 2020
(86) PCT No.: PCT/JP2020/021624

§ 371 Date: Nov. 15, 2021

(30) Foreign Application Priority Data
Jun. 5, 2019 (JP) 2019-105434

(51) Int. Cl. H01R 13/436; H01R 43/20; H01R 13/52

(52) U.S. Cl. CPC H01R 13/4364; H01R 13/5202; H01R 43/20

(57) ABSTRACT

A locking plate portion is disposed so as to be movable in a lateral direction. A connection terminal is inserted while a locking piece of a connection portion of the connection terminal passes through an insertion groove of the locking plate portion Subsequently, an operating member is pushed in an arrow direction with respect to the locking plate portion and the locking plate portion is laterally moved by a wedge mechanism. Then, the locking piece is transferred to a locking portion provided in the front end side portion of the insertion groove. As a result, the locking portion locks the rear portion of the locking piece and a rearward movement of the connection terminal is regulated.

### FIELD OF THE DISCLOSURE

The present invention relates to an electrical connector that is used for automotive electric circuit connection or the like and can be reliably held in a housing even with a small connection terminal and a method for locking a connection terminal in the electrical connector.

### BACKGROUND OF THE DISCLOSURE

In the related art, a connection terminal incorporated in the housing of an electrical connector is prone to so-called back slip (pulling out to the rear from the housing) when a strong force is applied to the electric wire pulled out to the outside during harness processing or attachment to a car body. The back slip of the connection terminal impairs the function as an electrical connector, and thus the back slip is prevented by a locking mechanism provided in the housing and, in general, a flexible case lance provided in the housing performs locking.

In recent years, however, a case lance alone is unlikely to be enough for a sufficient locking force as housings and case lances are required to be reduced in size along with connection terminals.

Known in this regard is an electrical connector in which a case lance locks a connection terminal in a housing, a wide side holder is inserted from the side of the housing, and the connection terminal is locked in the housing as in Patent Document 1.

In this electrical connector, the main body portion of the side holder is inserted in the housing from the side portion of the housing. In a case where the connection terminal is locked in the housing, the locking piece attached to the connection terminal is locked by the inserted side holder.

### CITATION LIST

### Patent Document

Patent Document 1: JP-A-2011-86504

### SUMMARY OF THE DISCLOSURE

### Technical Problem

However, in the electrical connector of Patent Document 1, a large hole portion for side holder insertion has to be formed in the side portion of the housing, it is difficult to waterproof the hole portion, and water infiltration into the housing is likely to occur. Accordingly, the electrical connector of Patent Document 1 is not suitable as an electrical connector requiring waterproofness during inter-connection terminal connection.

In addition, the side holder has an end portion exposed on the outer surface of the side portion of the housing at all times, and thus the side holder may escape from the housing due to an unexpected contact with another member.

### Solution to Problem

An object of the invention for solving the above problems is to provide an electrical connector and a method for locking a connection terminal in the electrical connector in which the incorporated connection terminal is reliably locked and prevented from escaping to the rear by a locking plate portion incorporated in a housing being moved in the housing by an operating member inserted from the front of the housing.

### Advantageous Effects of the Invention

According to the electrical connector and the method for locking the connection terminal in the electrical connector of the invention, the connection terminal is locked by the movable locking plate portion provided in the housing main body being moved by the operating member of another member inserted from the front, and thus the connection terminal can be reliably held in the housing.

In addition, it is possible to maintain waterproofness in the state of fitting with the electrical connector on the other side by forming the push-in port for pushing in the operating member in the front surface of the housing main body.

### BRIEF DESCRIPTION OF THE DRAWINGS

FIG. 1 is a perspective view in which an assembled electrical connector is seen from the front

FIG. 2 is a perspective view in which the assembled electrical connector is seen from the rear.

FIG. 3 is a perspective view in which a disassembled electrical connector is seen from the rear.

FIG. 4 is a vertical cross-sectional view in which the assembled electrical connector is vertically cut.

FIG. 5 is a vertical cross-sectional view in which the assembled electrical connector is horizontally cut.

FIG. 6 is a perspective view of a connection terminal.

FIG. 7 is a plan view of a locking plate portion.

FIG. 8 is a front view of the locking plate portion.

FIG. 9 is a plan view of an operating member.

FIG. 10 is a perspective view of a state where the locking plate portion is connected to a terminal holder.

FIG. 11 is a vertical cross-sectional view in which a housing is vertically cut with the terminal holder temporarily inserted.

FIG. 12 is a vertical cross-sectional view in which a housing is horizontally cut with the terminal holder temporarily inserted.

FIG. 13 is a vertical cross-sectional view of the process of primarily inserting the connection terminal in the temporary insertion state of the terminal holder.

FIG. 14 is a vertical cross-sectional view of a state where the connection terminal is secondarily inserted.

FIG. 15 is a vertical cross-sectional view of a state where the locking plate portion is inserted in the main insertion state of the terminal holder.

FIG. 16 is an explanatory diagram of the process of pushing in the operating member and laterally moving the locking plate portion.

### DETAILED DESCRIPTION OF THE EXEMPLARY EMBODIMENTS

The invention will be described in detail with reference to the illustrated example.

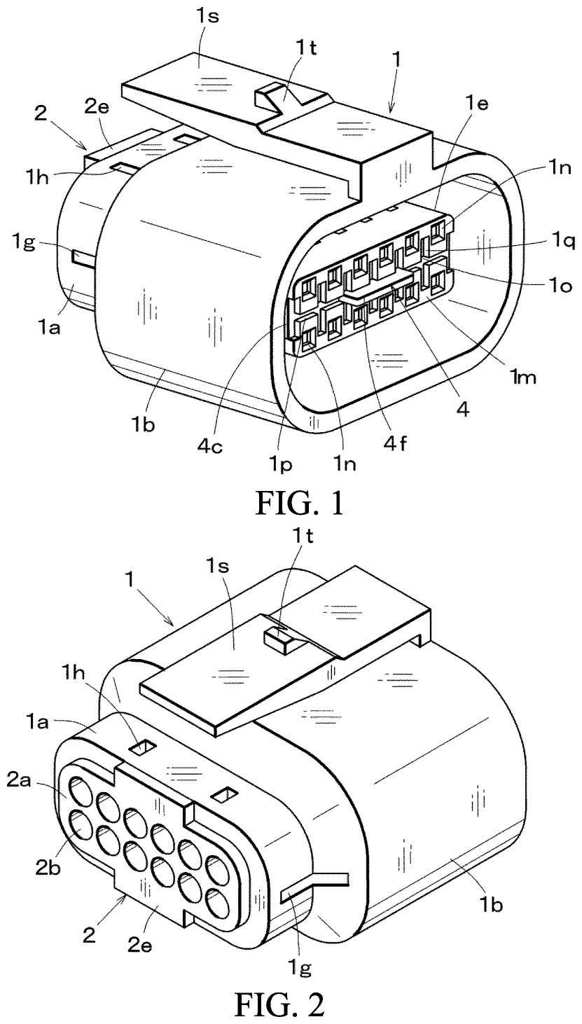

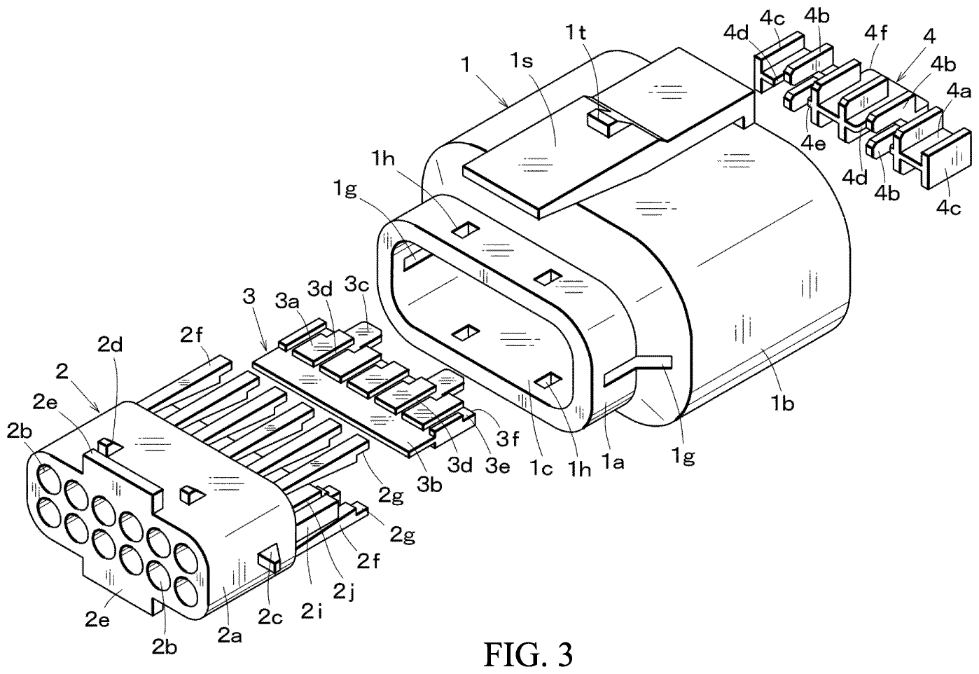

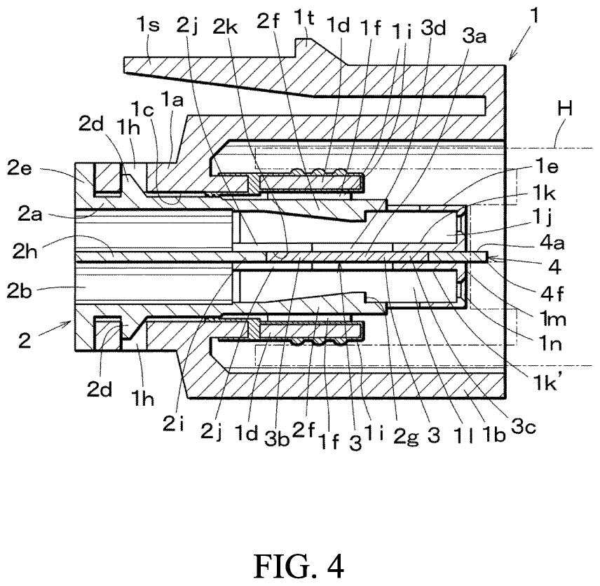

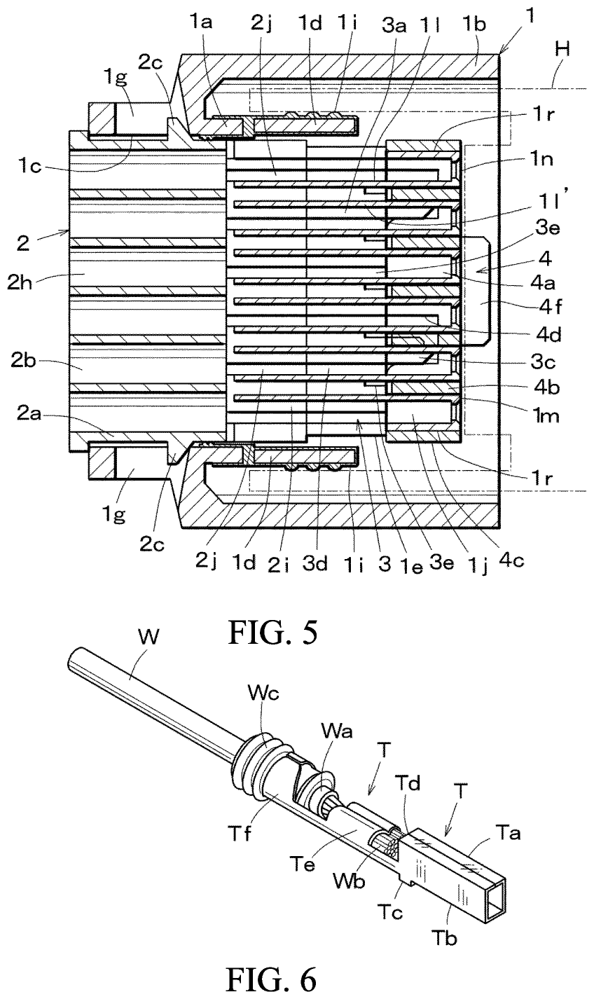

FIG. 1 is a perspective view in which the electrical connector of the example that is assembled is seen from the front. FIG. 2 is a perspective view in which the assembled electrical connector is seen from the rear. FIG. 3 is a perspective view of a disassembled state seen from the rear. FIG. 4 is a vertical cross-sectional view in which the assembled electrical connector is vertically cut. FIG. 5 is a vertical cross-sectional view in which the assembled electrical connector is horizontally cut.

The electrical connector includes a housing main body 1, a terminal holder 2 inserted into the housing main body 1 from the rear of the housing main body 1, a locking plate portion 3 connected to the front end of the terminal holder 2 and movable in the lateral direction that is orthogonal to the direction in which the terminal holder 2 is inserted, and an operating member 4 inserted from the front of the housing main body 1 and internally moving the locking plate portion 3 in the lateral direction. It should be noted that each of the housing main body 1, the terminal holder 2, the locking plate portion 3, and the operating member 4 is made of a synthetic resin material and manufactured by injection molding.

The terminal holder 2 incorporating a connection terminal (described later) is inserted inward from the rear portion of the housing main body 1. In addition, the locking plate portion 3 is connected to the tip of the terminal holder 2 so as to be movable in the lateral direction, the locking plate portion 3 is inserted into the housing main body 1 together with the terminal holder 2, and the locking plate portion 3 is operated by the operating member 4 pushed in from the front portion of the housing main body 1. As a result of this operation, the locking plate portion 3 moves in the lateral direction that is orthogonal to the direction in which the locking plate portion 3 is inserted with respect to the terminal holder 2 and locks the rear end of the locking piece of the incorporated connection terminal.

In the example of the electrical connector, for example, a total of 12 receiving-type connection terminals (so-called female terminals, six rows in the upper stage and six rows in the lower stage) can be incorporated from the rear side and inter-connection terminal electrical connection is performed by connection on the front side to a counterpart electrical connector incorporating the same number of insertion-type connection terminals (so-called male terminals).

The size of this small electrical connector that is assembled is, for example, 24 mm in width, 14 mm in height, and 24 mm in length. An appropriate size can be adopted in accordance with, for example, the size and number of the connection terminals.

The connection terminal incorporated in the housing main body 1 will be described first. As illustrated in the perspective view of FIG. 6, the connection terminal is, for example, a receiving-type connection terminal with a total length of 15 mm formed by punching and bending a conductive metal plate (such as a brass plate) with a thickness of, for example, 0.15 mm. A square tube-shaped receiving connection portion Ta approximately 4.8 mm in length, 1.1 mm in width, and 1.6 mm in height is formed in the front portion of a connection terminal T. It should be noted that the dimensions do not limit the size of the connection terminal T.

On one width-direction side of the rear end of a bottom surface Tb of the connection portion Ta, a locking piece Tc formed by a notch in the bottom surface Tb and locked by the locking plate portion 3 protrudes downward and along the front-rear direction. The locking piece Tc is formed to have a height of, for example, 0.4 mm with the side end portion cut out in a fin shape directed downward once and then folded back upward in a U shape.

The locking piece Tc serves as a guide when the connection terminal T is inserted, serves as a stabilizer for stabilizing the posture of the connection terminal after the insertion, and has a function of preventing the connection terminal T itself from escaping to the rear. Further, the upper end of the rear portion of the connection portion Ta is a pressed portion Td against which the case lance formed on the terminal holder 2 abuts from the rear.

An electric wire W with an outer diameter of approximately 1 mm covered with a covering portion Wa is connected to the rear end portion of the connection terminal A core wire portion Wb at the tip of the electric wire W exposed from the covering portion Wa, is crimp-connected to the connection terminal T by bending a U-shaped core wire crimping portion Te. Further, behind the core wire crimping portion Te, a cylindrical sealing material Wc made of a synthetic rubber for waterproofing and inserted outside the covering portion Wa is crimp-fixed together with the covering portion Wa by bending a U-shaped covering crimping portion Tf.

A middle tube 1a is provided in the middle portion of the housing main body 1. An outer tube 1b is disposed, with a gap, on the outside of the housing main body 1 so as to largely surround the middle tube 1a. The rear portion of the outer tube 1b is connected behind the middle tube 1a, and the middle tube 1a and the outer tube are integrally molded.

In the rear portion of the middle tube 1a, a holder holding portion 1c is open rearward so that the terminal holder 2 can be inserted. The rear frame portion of the inserted terminal holder 2 is held by the holder holding portion 1c, and the front end of the middle tube 1a inside the outer tube 1b is a waterproof portion 1d slightly reduced in outer diameter.

A tubular terminal holding portion 1e smaller in diameter than the middle tube 1a is formed further forward inside the middle tube 1a and with a slight gap from the middle tube 1a. The terminal holding portion 1e is supported by a plurality of ribs 1f from the inside of the middle tube 1a. It should be noted that a gap is provided between the ribs 1f so that the case lance of the terminal holder 2 (described later) can enter. The terminal holding portion 1e is for holding the connection portion Ta of the connection terminal T therein, and the front wall of the terminal holding portion 1e is almost blocked with an opening portion (described later) and the operating member 4 left.

Long groove-shaped coupling groove portions 1g for temporary insertion are formed as mechanisms for coupling the housing main body 1 and the terminal holder 2 to each other. The coupling groove portions 1g are formed in both side portions of the holder holding portion i.e. When the terminal holder 2 is temporarily inserted, a coupling protrusion 2c for temporary insertion of the terminal holder 2 is fitted into the coupling groove portion 1g. In addition, two coupling groove portions 1h for main insertion in the upper portion of the holder holding portion 1c and two coupling groove portions 1h for main insertion in the lower portion of the holder holding portion 1c are formed as similar coupling mechanisms to receive coupling protrusions 2d for main insertion, which are provided on the terminal holder 2, during the main insertion of the terminal holder 2.

During the use of the electrical connector, a housing H on the other side is inserted between the middle tube 1a and the outer tube 1b. For this reason, the periphery of the tip of the middle tube 1a. is surrounded by a synthetic rubber made of, for example, silicon rubber as a waterproof member with respect to the housing H. This seal portion 1i is connected on both the inner and outer surfaces of the middle tube 1a via the small hole provided in the waterproof portion 1d and, on both the inner and outer surfaces, each cross section is wavy so that water infiltration is effectively blocked. It is preferable that the seal portion 1i is attached during the injection molding of the housing main body 1 and further cross-linked.

A total of 12 connection portion accommodating chambers 1j (six rows on the left and six rows on the right in the upper and lower stages) with a square cross section are provided in the terminal holding portion 1e and individually store the connection portions Ta of the connection terminals T. Bottom plates 1k and 1k′ for respectively supporting the bottom surfaces Tb of the connection terminals T are disposed back to back with a gap between the upper and lower connection portion accommodating chambers 1j. The total thickness of the bottom plates 1k and 1k′ including the gap is, for example, 1.4 mm.

On both the upper and lower surfaces of the bottom plates 1k and 1k′, a total of 10 sets of partition walls 1l and 1l′ (one upper wall and one lower wall constituting one set) extend with sufficient length in the longitudinal direction so that the connection terminals T adjacent to the right and left are partitioned. A gap is provided between the partition walls 1l and 1l′. Further, the space surrounded by the bottom plates 1k and 1k′ and the partition walls 1l and 1l′ is the connection portion accommodating chamber 1j where the connection portion Ta is individually stored. It should be noted that the horizontal plate of the operating member 4 (described later) is inserted into the gap between the bottom plates 1k and 1k′ and the vertical plate of the operating member 4 is inserted into the gap between the partition walls 1l and 1l′.

Although the front surface of the terminal holding portion 1e is blocked by a front wall 1m, a total of 12 quadrangular opening portions in (six above and six below), into which the insertion ends of the insertion-type connection terminals on the other side are respectively inserted, are formed in the front wall 1m so as to correspond to the inserted individual connection terminals T. Further, the front wall 1m is provided with a push-in port 1o for the operating member 4 inserted into the housing main body 1 so that the locking plate portion 3 is moved in the lateral direction. It should be noted that one horizontal groove 1p and a plurality of vertical grooves 1q are formed as the push-in port 1o, the horizontal groove 1p is provided between the upper and lower opening portions 1n, the vertical groove 1q is provided between the right and left opening portions 1n, the horizontal groove 1p communicates with the gap between the bottom plates 1k and 1k′ of the terminal holding portion 1e, and the vertical groove 1g communicates with the gap of the partition walls 1l and 1l′.

Recess portions 1r into which the side plates on both sides of the operating member 4 are fitted are provided on both the right and left outer sides of the terminal holding portion 1e. Further, an elastic locking arm 1s for locking and maintaining the state of connection to the counterpart connector is formed in the upper middle portion of the outer tube 1b of the housing main body 1 and a locking claw 1t protrudes thereon.

A frame portion 2a inserted into the holder holding portion 1c of the middle tube 1a is provided in the rear portion of the terminal holder 2. The frame portion 2a is provided with a total of 12 open holes 2b (six rows on the left and six rows on the right in the upper and lower stages) into which the connection terminals T are individually inserted. The open holes 2b have a circular cross section and a diameter of, for example, approximately 2.3 mm.

The coupling protrusions 2c for temporary insertion fitted in the coupling groove portions 1g for temporary insertion of the holder holding portion 1c with the terminal holder 2 temporarily inserted protrude outward one by one on both the right and left side portions of the frame portion 2a. In addition, each of the upper and lower portions of the frame portion 2a is provided with two coupling protrusions 2d for main insertion and the four upward and downward coupling protrusions 2d are fitted in the coupling groove portions 1h for main insertion of the holder holding portion 1c in the main insertion state. Further, a stopper 2e for stopping the insertion of the terminal holder 2 with respect to the middle tube 1a during the main insertion at a predetermined position is provided upward and downward in the rear end portion of the terminal holder 2.

It should be noted that the coupling protrusions 2c and 2d may be provided on the holder holding portion 1c and the coupling groove portions 1g and 1h may be provided in the frame portion 2a.

From the upper and lower portions of the front portions of the open holes 2b of the frame portion 2a, a total of 12 elastic case lances 2f (six each) protrude forward for each incorporated connection terminal T. As for the connection terminals T, the six connection portions Ta in the connection portion accommodating chambers 1j of the upper stage of the terminal holding portion 1e and the six connection portions Ta in the connection portion accommodating chambers 1j of the lower stage of the terminal holding portion 1e are incorporated in vertical symmetry, and thus the upper and lower case lances 2f are provided in vertical symmetry so as to correspond thereto. In addition, a hook portion 2g for abutting against and pressing the pressed portion Td of the connection portion Ta of the connection terminal T from the rear is formed in the vicinity of the tip of each case lance 2f and the upper and lower hook portions 2g are provided in vertical symmetry.

A partition portion 2h partitioning the open holes 2b upward and downward and having a semicircular arc-shaped inner cross section continuous with the open hole 2b is provided between the upper and lower open holes 2b of the frame portion 2a. The thinnest part of the partition portion 2h has a thickness of 0.45 mm. Further, a flat plate-shaped terminal placement plate 2i extends in front of the partition portion 2h. The terminal placement plate 2i has a thickness of, for example, 1.4 mm and allows the bottom surface Tb of each connection terminal T to be placed on both the upper and lower surfaces.

Six insertion grooves 2j are formed in the front-rear direction in each of the upper and lower surfaces of the terminal placement plate 2i so that the locking piece Tc passes forward during the insertion of the connection terminal T. The insertion groove 2j has, for example, a width of 0.6 mm and a depth of 0.4 mm. It should be noted that the locking piece Tc is formed close to one width-direction side of the connection portion Ta and thus the upper and lower insertion grooves 2j are formed so as to be mutually misaligned in bilateral symmetry.

The lopsided formation of the insertion grooves 2j is the same as in the case of the insertion grooves in both the upper and lower surfaces of the locking plate portion 3 illustrated in FIG. 8 (described later). In addition, a wide slit-shaped connecting hole 2k is formed at the front end of the terminal placement plate 2i so that the insertion plate of the locking plate portion 3 (described later) is received so as to be movable in the lateral direction.

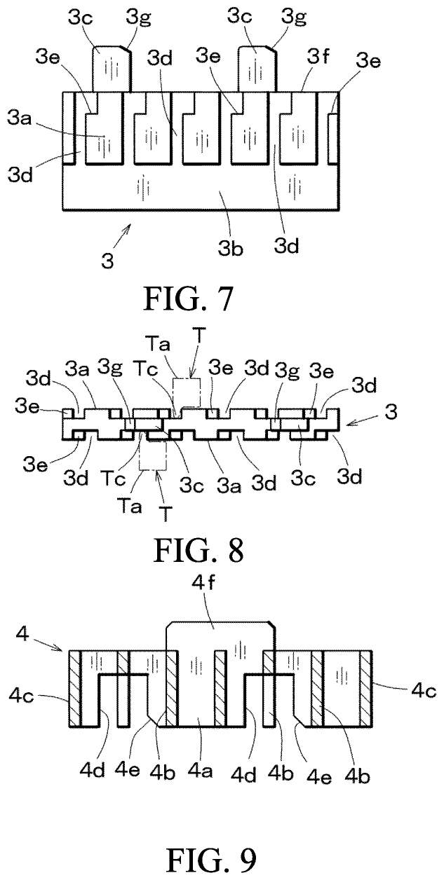

As illustrated in the plan view of FIG. 7 and the front view of FIG. 8, the locking plate portion 3 includes a substrate portion 3a, an insertion plate 3b protruding rearward, and two operated ends 3c protruding forward. The substrate portion 3a is a substantially rectangular plate body with a thickness of 1.4 mm, which is the same as the gap of the bottom plates 1k and 1k′ of the terminal holding portion 1e and the gap of the terminal placement plate 2i of the terminal holder 2.

A total of six insertion grooves 3d are formed in the front-rear direction in each of the upper and lower surfaces of the substrate portion 3a. The 12 insertion grooves 3d communicate with the insertion grooves 2j in the terminal placement plate 2i at the position of insertion and connection of the locking plate portion 3 into and to the terminal holder 2 and have a width of 0.6 mm and a depth of 0.4 mm as in the case of the insertion groove 2j. In addition, a stepped notch provided in the width direction is formed in the front end side portion of each insertion groove 3d. The notch is a locking portion 3e for locking the locking piece Tc such that the connection terminal does not escape to the rear.

It should be noted that the one-dot chain line in FIG. 8 indicates a state where the locking piece Tc of the connection terminal is inserted through the insertion groove 3d of the locking plate portion 3.

Although the insertion plate 3b is fitted into the connecting hole 2k of the terminal holder 2, the insertion plate 3b is narrower than the connecting hole 2k and has a plate body shape having a thickness of approximately 0.6 mm. In addition, the operated end 3c is a strip having a thickness of approximately 0.6 mm and protruding forward from a front edge 3f of the substrate portion 3a. A receiving slope portion 3g is formed on one side of the tip of the operated end 3c. The receiving slope portion 3g is a wedge mechanism for redirection for laterally moving the locking plate portion 3 with respect to the housing main body 1 and the terminal holder 2 by means of the operating member 4.

The operating member 4 is a member for laterally moving the internal locking plate portion 3 by pushing into the terminal holding portion 1e from the push-in port 1o of the front wall 1m of the housing main body 1. As illustrated in the plan view of FIG. 9, the operating member 4 includes a horizontal plate 4a with a thickness of 0.6 mm entering the gap of the bottom plates 1k and 1k′, a plurality of vertical plates 4b with a thickness of 0.6 mm entering the gap of the partition walls 1l and 1l′, and a pair of side plates 4c on both sides.

Two recess portions 4d receiving the operated end 3c of the locking plate portion 3 are formed in the insertion direction of the horizontal plate 4a, that is, at the front end. At two locations on one side of the entrance of the recess portion 4d, a push slope portion 4e as an operating portion is provided in order to laterally move the locking plate portion 3 in cooperation with the receiving slope portion 3g of the operated end 3c. In addition, a push-in piece 4f is provided at the rear end of the horizontal plate 4a so that the operating member 4 is pushed in and the operating member 4 is pulled out as needed.

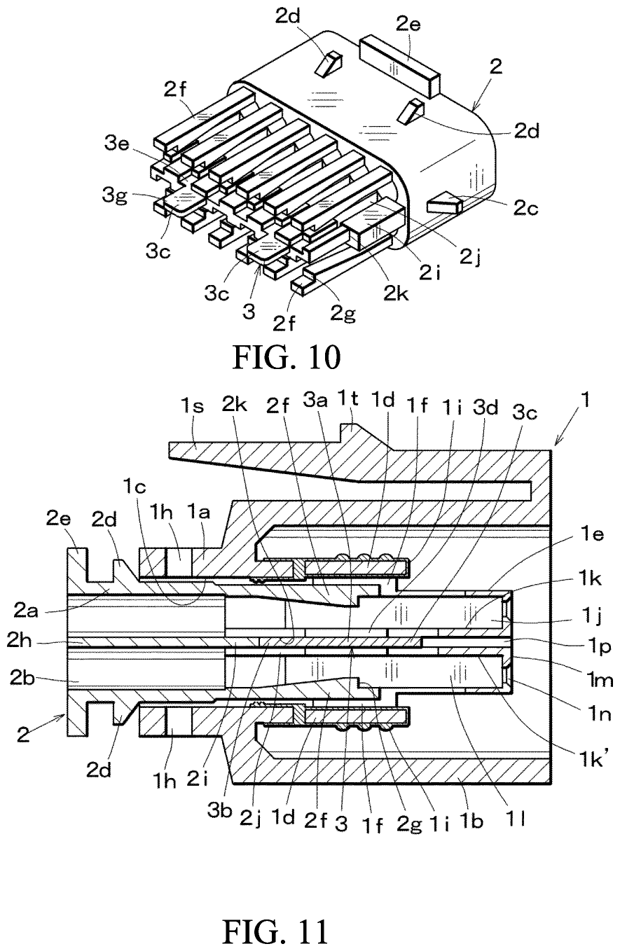

As illustrated in FIG. 10, during the assembly of the electrical connector, the insertion plate 3b of the locking plate portion 3 is inserted into the connecting hole 2k at the tip of the terminal holder 2 and the locking plate portion 3 is connected to the terminal holder 2 so as to be movable in the lateral direction. In this case, the insertion plate 3b is brought close to one side with respect to the connecting hole 2k of the terminal placement plate 2i. As a result, the insertion groove 3d of the locking plate portion 3 communicates with the insertion groove 2j of the terminal placement plate 2i and the locking piece Te of the connection terminal T is capable of passing through the insertion grooves 2ⱼ and 3d in sequence.

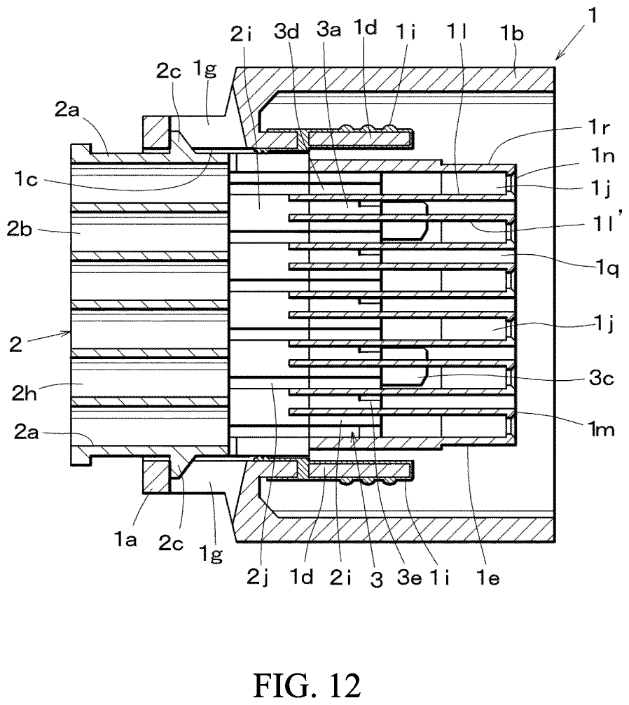

The assembly in which the terminal holder 2 and the locking plate portion 3 are integrated in this manner is inserted from the rear of the housing main body 1 into the holder holding portion 1c of the middle tube 1a along a guide mechanism (not illustrated). As a result of this insertion, the frame portion 2a of the terminal holder 2 is assembled, as a temporary insertion state, to the holder holding portion 1c as illustrated in FIGS. 11 and 12.

In this temporary insertion state, the front end of the operated end 3c of the locking plate portion 3 is positioned near the gap between the bottom plates 1k and 1k′ of the terminal holding portion 1e. When the terminal holder 2 and the locking plate portion 3 are temporarily inserted into the housing main body 1, the coupling protrusion 2c for temporary insertion of the terminal holder 2 pushes and expands the holder holding portion 1c of the housing main body 1 to the right and left, which leads to fitting and coupling to the coupling groove portion 1g for temporary insertion, and the front end of the coupling protrusion 2d for main insertion abuts against the rear end portion of the holder holding portion 1c. In this temporary insertion state, the case lance 2f provided on the terminal holder 2 is positioned between the ribs 1f between the terminal holding portion 1e and the waterproof portion 1d.

In this temporary insertion state, the rear end portion of the holder holding portion 1c is sandwiched and coupled by the coupling protrusion 2c for temporary insertion and the coupling protrusion 2d for main insertion. Accordingly, the terminal holder 2 and the locking plate portion 3 do not fall off from the housing main body 1 and the temporary insertion state is maintained. In this manner, the state of assembly of the assemblies does not collapse even in the event of transport of the assembly in which the terminal holder 2 and the locking plate portion 3 are temporarily inserted with respect to the housing main body 1 to the insertion workplace for the connection terminal T for the next process.

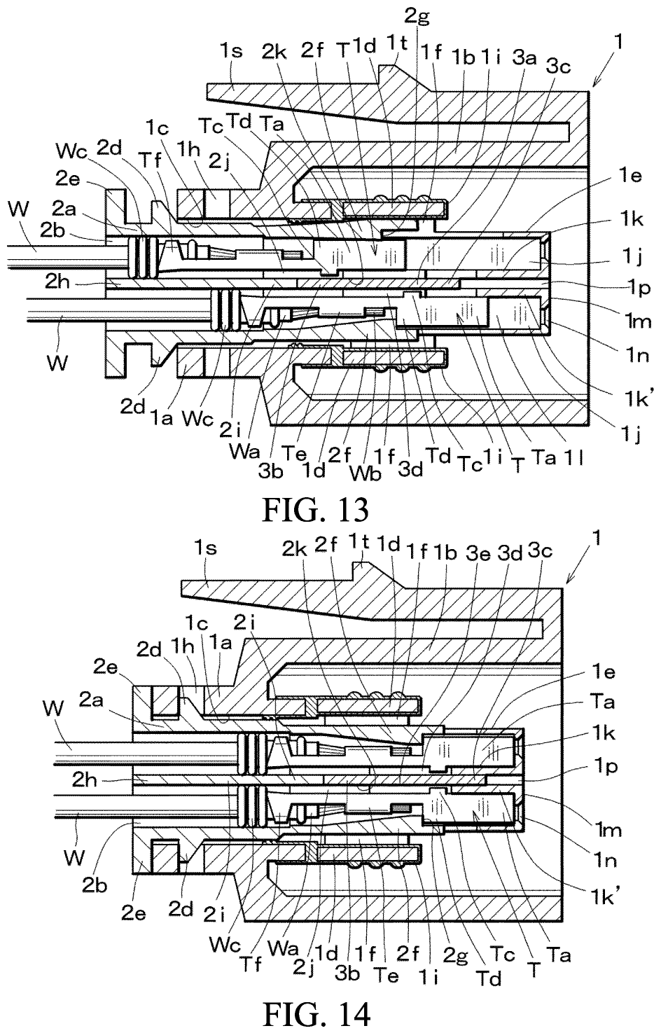

Next, as illustrated in FIG. 13, the individual connection terminals T are primarily inserted into the terminal holder 2 from the open hole 2b of the terminal holder 2 starting from the connection portion Ta of the connection terminal T. The individual connection portions Ta proceed on the terminal placement plate 2i while being guided by the partition walls 1l and 1l′ extending rearward from the terminal holding portion 1e. This entails a forward movement of the locking piece Tc of the connection portion Ta in the insertion groove 2j of the terminal placement plate 2i and, further, the insertion groove 3d of the locking plate portion 3.

It should be noted that the connection terminals T during the mounting into the terminal holder 2 are disposed in vertical symmetry in the housing main body 1 and the bottom surfaces 1d are inserted back to hack.

In the primary insertion process of the connection terminal T, the connection portions Ta at the tips of the connection terminals T in the upper stage and at the lower limit push up and down the hook portion 2g of the case lance 2f pass through the hook portion 2g of the case lance 2f and enter the connection portion accommodating chamber 1j as in the case of the connection terminal T in the upper stage. The case lance 2f and the waterproof portion 1d of the middle tube T a have a slight gap therebetween and the case lance 2f is deformable to the outside. When the connection portion Ta passes through the hook portion 2g, the case lance 2f returns to the original posture and the hook portion 2g abuts against the pressed portion Td of the connection portion Ta. Then, each connection terminal T stops at this primary insertion position as in the case of the connection terminal in the lower stage.

After the completion of the primary insertion of every connection terminal T, the terminal holder 2 is further pushed into the middle tube 1a together with the locking plate portion 3. As a result, the hook portion 2g of the case lance 2f pushes the pressed portion Id of the connection portion Ta forward as illustrated in FIG. 14 and the connection portion Ta of every connection terminal T is pushed in up to a predetermined position in the connection portion accommodating chamber 1j by the connection terminal T being moved forward from the primary insertion position to a secondary insertion position.

As a result, the operated end 3c of the locking plate portion 3 is inserted into the gap between the bottom plates 1k and 1k′ and, at the same time, the stopper 2e of the terminal holder 2 abuts against the rear end portion of the housing main body 1 and the terminal holder 2 and the locking plate portion 3 stop moving forward at this position. In this main insertion process, the coupling protrusion 2d for main insertion of the terminal holder 2 pushes and expands the holder holding portion 1c of the housing main body 1 up and down, which leads to fitting into the coupling groove portion 1b for main insertion, and the terminal holder 2 is coupled to the housing main body 1 in the main insertion state. In this main insertion state, the locking plate portion 3 and the terminal holder 2 incorporating the connection terminal T become immovable in the front-rear direction with respect to the housing main body 1 by the stopper 2e and the coupling protrusion 2d for main insertion of the terminal holder 2 sandwiching the rear end portion of the holder holding portion 1c.

In addition, as for the connection terminal T in this secondary insertion state, the front position is determined with the front end of the connection portion Ta in the connection portion accommodating chamber 1j abutting against the inside of the front wall 1m. In this stationary state of the connection terminal T, the hook portion 2g of the case lance 2f abuts against the pressed portion Td of the connection terminal T from the rear and the back slip of the connection terminal T is prevented. At this time, the locking piece Tc of the connection terminal T is stopped at the tip of the insertion groove 3d of the locking plate portion 3 via the insertion groove 2j of the terminal placement plate 2i as a stabilizer.

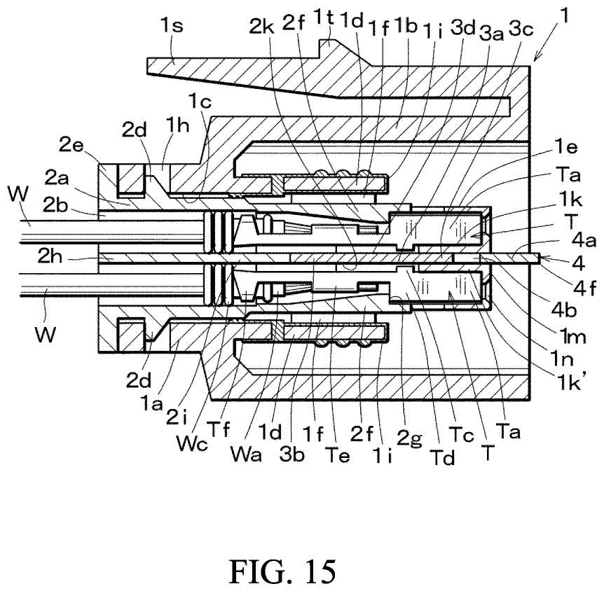

As illustrated in FIG. 15, in the main insertion state of the terminal holder 2 and the locking plate portion 3, the separate operating member 4 is pushed in from the push-in port to provided in the front wall 1m of the housing main body 1 and the horizontal plate 4a and the vertical plate 4b are pushed into the gaps of the bottom plates 1k and 1k′ and the partition walls 1l and 1l′. In addition, the side plates 4c on both sides of the operating member 4 are fitted into the recess portions it of the terminal holding portion 1e.

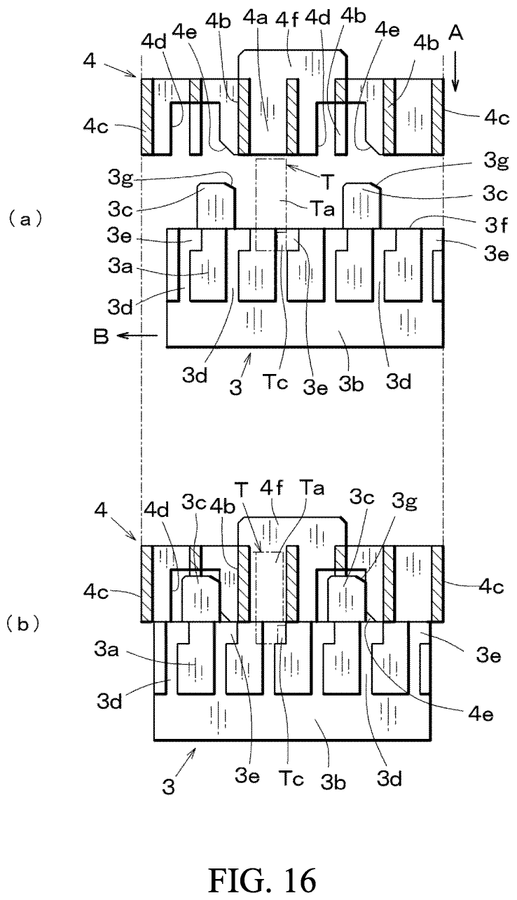

As a result, the locking plate portion 3 and the operating member 4 face each other in the housing main body 1 as illustrated in FIG. 16(a). It should be noted that the connection portion Ta and the locking piece Tc of the connection terminal T are indicated by one-dot chain lines. When the operating member 4 is strongly pushed in with respect to the locking plate portion 3 by means of the push-in piece 4f as indicated by the arrow A here, the operated end 3c of the locking plate portion 3 enters the recess portion 4d of the horizontal plate 4a of the operating member 4 as illustrated in FIG. 16(b). The pressing force of the operating member 4 causes the push slope portion 4e to apply a force proceeding in the lateral direction of the arrow B to the locking plate portion 3 by the inter-slope wedge action and with respect to the receiving slope portion 3g of the operated end 3c.

With the insertion plate 3b of the locking plate portion 3 positioned in the connecting hole 2k of the terminal placement plate 2i, the operated end 3c laterally moves in the gap of the bottom plates 1k and 1k′. As a result, the locking plate portion 3 moves laterally to the right when viewed from the front with respect to the terminal holder 2 and the housing main body 1. Further, at this position, a leftward movement of the locking plate portion 3 is regulated by the operating member 4, and thus the locking plate portion 3 does not unexpectedly return to the original position.

As a result of the lateral movement of the locking plate portion 3, the locking piece Tc positioned at the front end of the insertion groove 3d of the locking plate portion 3 is locked by the locking portion 3e provided on the side of the tip of the insertion groove 3d without the connection terminal T being moved. As a result, a rearward movement of the locking piece Tc is regulated. The lateral movement distance of the locking plate portion 3 is approximately 0.6 mm, which exceeds the width of the locking piece Tc. In this manner, the locking plate portion 3 does not return to the original position and the locking state of the locking piece Tc of the connection terminal T is maintained by the locking portion 3e insofar as the operating member 4 is inserted.

It should be noted that the description in FIG. 16 is a description of the operation on the upper surface of the locking plate portion 3, the same applies to the lower surface, and the rear portion of the locking piece Tc of the connection terminal T disposed on the lower surface side is locked by the locking portion 3e on the lower surface side.

When the operating member 4 is sufficiently pushed in, the locking plate portion 3 is reliably moved in the lateral direction and the locking of the locking piece Tc is visually confirmed from the front. When the operating member 4 is colored in a color different from, for example, the color of the housing main body 1 here, the mounting state of the operating member 4 can be visually recognized with greater ease. It should be noted that another method may be used as the mechanism of moving the locking plate portion 3 by means of the operating member 4.

In this manner, the pressed portion 1d is locked by the case lance 2f and the locking piece Tc is locked by the locking portion 3e of the locking plate portion 3 as for the connection terminal T. By these two locking means, back slip attributable to, for example, the electric wire W being pulled out to the rear of the connection terminal T is reliably prevented.

In addition, as illustrated in FIG. 15, the rear end portion of the connection terminal T at the main insertion position is positioned in the open hole 2b of the terminal holder 2, the cylindrical sealing material We attached to the connection terminal T is in close contact with the inner wall of the open hole 2b, and water infiltration from the rear into the terminal holder 2 and the middle tube 1a is prevented. Further, the inside part of the seal portion 1i provided on the waterproof portion 1d provides sealing between the inside of the middle tube 1a and the outside of the terminal holder 2 and inward water infiltration from the gap between the middle tube 1a and the terminal holder 2 is prevented.

The electrical connector configured as described above is fitted with the housing of the electrical connector on the other side during use, and the housings are locked by the locking claw 1t of the locking arm 1s. The insertion end of the connection terminal on the other side is inserted from the opening portion 1n of the front wall 1m and fitted into the connection portion Ta of the connection terminal T, and then the connection terminals are electrically connected. It should be noted that the push-in piece 4f of the operating member 4 at this time remains slightly protruding forward from the terminal holding portion 1e of the housing main body 1 and yet the push-in piece 4f is inserted into the recess of the housing of the counterpart connector when the connectors are fitted together.

The electrical connector on the other side also has a waterproof structure, the outer tube of the housing on the other side is inserted between the outer tube 1b and the middle tube 1a of the housing main body 1, the outside part of the seal portion 1i provided on the middle tube 1a provides sealing between the middle tube 1a and the outer tube of the housing H on the other side, and sealing is performed such that no inward water infiltration occurs from between the middle tube 1a and the outer tube of the housing H on the other side. In this manner, the sealing structure by means of the seal portion 1i and the cylindrical sealing material Wc prevents water infiltration into the holder holding portion 1c and fitting with the waterproof housing H on the other side leads to functioning as a waterproof connector.

In the example, the connection terminals T are inserted into the upper and lower stages of the electrical connector with the bottom surfaces Tb facing each other, and thus the insertion grooves 3d of the locking pieces Tc respectively formed in the locking plate portion 3 and the terminal placement plate 2i of the terminal holder 2 are formed in both the upper and lower surfaces. However, the insertion groove may be formed in only one surface in the case of an electrical connector in which the connection terminal T is incorporated in one stage.

In addition, the back slip regulation with respect to the locking piece Tc is released when the operating member 4 is pulled out by the push-in piece 4f and then the locking plate portion 3 is laterally moved to the left by a jig so that the connection terminal T is taken out of the housing main body 1 for repairing or the like. After the release, the case lance 2f may be unlocked with respect to the connection terminal T by dedicated jig insertion from the opening portion in of the front wall 1m and the connection terminal T may be pulled out rearward.

In the example described above, the locking plate portion 3 is provided with the locking portion 3e locking the locking piece Tc of the connection terminal T. However, when the lengths of the bottom plates 1k and 1k′ in the front-rear direction are increased, every connection portion Ta is caused to reach parts on the bottom plates 1k and 1k′ during the secondary insertion of the connection terminal T, and the bottom plates 1k and 1k′ are also provided with the insertion groove of the locking piece Tc, the locking piece Tc can be pushed into the insertion grooves in the bottom plates 1k and 1k′ during the secondary insertion of the connection terminal T. Then, the locking of the locking piece Tc can also be performed not by the locking portion 3e but by the front edge 3f of the laterally moved locking plate portion 3 blocking the insertion grooves in the bottom plates 1k and 1k′.

In addition, although the insertion groove 2j is also provided in the terminal placement plate 2i of the terminal holder 2, the insertion groove 2j of the terminal holder 2 can be omitted insofar as the locking piece Tc of the connection terminal T can be directly guided to the insertion groove 3d of the locking plate portion 3 during the insertion of the connection terminal T.

Although the connection terminal T is a receiving-type connection terminal in the example, the invention is also applicable to an electrical connector in which the connection terminal is an insertion-type connection terminal. Further, the number of the connection terminals T can be changed and the number of the stages can be one or three or more.

It should be noted that the terms of up, down, right, left, front, and rear in the example are described with respect to the drawings and may differ from those in an actual electrical connector.

### REFERENCE SIGNS LIST

1 Housing main body
1a Middle tube
1b Outer tube
1c Holder holding portion
1e Terminal holding portion
1j Connection portion accommodating chamber
1k, 1k′ Bottom plate
1l, 1l′ Partition wall
1m Front wall
1n Opening portion
1o Push-in port
2 Terminal holder
2a Frame portion
2b Open hole
2f Case lance
2i Terminal placement plate
2j, 3d Insertion groove
3 Locking plate portion
3a Substrate portion
3b Insertion plate
3c Operated end
3e Locking portion
3g Receiving slope portion
4 Operating member
4a Horizontal plate
4b Vertical plate
4e Push slope portion
T Connection terminal
Ta Connection portion
Tc Locking piece
W Electric wire

1. An electrical connector comprising:
a housing main body;
a terminal holder inserted into the housing main body from a rear of the housing main body and incorporating a plurality of connection terminals having locking pieces;
a locking plate portion connected to a front end of the terminal holder and movable in a lateral direction orthogonal to the direction in which the terminal holder is inserted; and
an operating member moving the locking plate portion inserted in the housing main body together with the terminal holder in the lateral direction, wherein
the housing main body is provided with a holder holding portion holding the terminal holder in a rear portion and a terminal holding portion individually holding a connection portion of the connection terminal in a front portion,
a plurality of open holes into which the connection terminals are respectively inserted are provided in a rear portion of the terminal holder,
an insertion groove allowing the locking piece of the connection terminal to pass through a substrate portion is formed in the locking plate portion, an insertion plate connected to the terminal holder so as to be movable in the lateral direction is provided in a rear portion of the substrate portion, and an operated end for a movement in the lateral direction by the operating member is provided at a part of the substrate portion,
the operating member is provided with an operating portion pushed in from a push-in port provided in the terminal holding portion of the housing main body and acting on the operated end of the locking plate portion, and
as a result of the push, the operating portion of the operating member moves the locking plate portion in the lateral direction, locking is performed by the locking plate portion with respect to the locking piece of the connection terminal, and a back slip of the connection terminal is regulated.

2. The electrical connector according to claim 1, wherein a stepped locking portion is provided in a front end side portion of the insertion groove of the locking plate portion and the locking portion regulates the back slip of the connection terminal by the locking plate portion moving in the lateral direction.

3. The electrical connector according to claim 1, wherein an insertion groove communicating with the insertion groove of the locking plate portion is formed in a bottom plate of the terminal holding portion of the housing main body and the insertion groove of the bottom plate is blocked and the locking piece of the connection terminal is locked by the locking plate portion moving in the lateral direction.

4. The electrical connector according to claim 1, wherein the connection terminals are incorporated in one upper stage and one lower stage with respect to the terminal holder and the insertion grooves of the locking plate portion are formed in both upper and lower surfaces of the locking plate portion.

5. The electrical connector according to claim 1, wherein the terminal holder is provided with an insertion groove so as to communicate with the insertion groove of the locking plate portion.

6. The electrical connector according to claim 1, wherein the locking plate portion is moved in the lateral direction by a wedge action with the operated end of the locking plate portion by the operating portion of the operating member abutting against the locking plate portion and being pushed in.

7. The electrical connector according to claim 1, wherein the operating member in an insertion state thereof functions as confirmation means for confirming the movement of the locking plate portion in the lateral direction.

8. The electrical connector according to claim 1, wherein the push-in port of the operating member is provided in a front surface of the terminal holding portion of the housing main body.

9. The electrical connector according to claim 1, wherein the terminal holder allows an elastic case lance to protrude forward and the case lance locks a part of the connection terminal.

10. The electrical connector according to claim 1, wherein the terminal holding portion of the housing main body has a waterproof structure preventing water infiltration.

11. A method for locking a connection terminal in an electrical connector including a housing main body, a terminal holder inserted into the housing main body from a rear of the housing main body and incorporating a plurality of connection terminals having locking pieces, a locking plate portion connected to a front end of the terminal holder and movable in a lateral direction orthogonal to the direction in which the terminal holder is inserted, and an operating member moving the locking plate portion inserted in the housing main body together with the terminal holder in the lateral direction,
wherein, in the method for locking the electrical connector, a rear portion of the locking plate portion is connected to the terminal holder so as to be movable in the lateral direction, the connection terminal is inserted by the locking piece of the connection terminal moving forward in an insertion groove formed in the locking plate portion when the connection terminal is inserted, the locking plate portion is moved in the lateral direction by the operating member being pushed into the housing main body from a push-in port provided in the housing main body after the insertion of the connection terminal, and a rear portion of the locking piece of the connection terminal is locked and a rearward movement of the connection terminal is regulated as a result.
